(19) United States
(12) Patent Application Publication
(10) Pub. No.: US 2012/0110424 A1
(43) Pub. Date: May 3, 2012

(54) ELECTRONIC DEVICE AND METHOD OF CONTROLLING THE SAME

(75) Inventor: Sangwon Kim, Seoul (KR)

(73) Assignee: LG Electronics Inc.

(21) Appl. No.: 12/916,327

(22) Filed: Oct. 29, 2010

(51) Int. Cl. G06F 17/00

(52) U.S. Cl. 715/206

(57) ABSTRACT

An electronic device and a method of controlling the electronic device are provided. The electronic device can automatically generate a bookmark with respect to contents currently output from the electronic device when an event is generated in another electronic device while the electronic device is outputting the contents in order to provide an environment in which a user can watch the contents seamlessly.

### FIELD OF THE INVENTION

The present invention is directed to a bookmark in a network environment including electronic devices which can communicate with each other, and more specifically, to an electronic device automatically generating a bookmark for contents being played when a predetermined event is generated in another electronic device linked to a network and a method of controlling the electronic device.

### DESCRIPTION OF THE RELATED ART

With recent hardware and software developments, electronic devices of different types are often present on a single network. Furthermore, protocols are provided in the electronic devices of different types in order to enable communication between the electronic devices.

An effective method is required for controlling electronic devices such that they are compatible with each other in a networking environment.

### SUMMARY OF THE INVENTION

In one aspect of the present invention, a method for generating a bookmark related to contents output by an electronic device is provided. The method includes outputting the contents from the electronic device, receiving information in the electronic device, the information related to an event generated in a different electronic device while the contents are output from the electronic device, generating the bookmark in the electronic device that is related to the contents and outputting information related to the generated bookmark from the electronic device.

It is contemplated that the method further includes no longer outputting the contents from the electronic device upon generating the bookmark. It is further contemplated that the method further includes resuming output of the contents from the electronic device based on the generated bookmark upon receiving information related to termination of the event.

It is contemplated that the method further includes storing at least the contents or the information related to the generated bookmark while no longer outputting the contents, where resuming output of the contents includes obtaining at least the stored contents or the stored information related to the generated bookmark. It is further contemplated that at least the contents or the information related to the generated bookmark is stored in the electronic device.

It is contemplated that at least the contents or the information related to the generated bookmark is stored in a server. It is further contemplated that the method further includes determining if time information related to the contents is available, storing the contents if the time information is not available and not storing the contents if the time information is available. It is further contemplated that determining if time information related to the contents is available includes determining if a reproduction state variable is received.

It is contemplated that resuming output of the contents includes providing a user interface upon receiving the information related to termination of the event and resuming output of the contents according to user input received via the user interface. It is further contemplated that the method further includes deleting the generated bookmark upon completion of the output of the contents based on the generated bookmark.

It is contemplated that generating the bookmark includes determining a priority of the generated event based on the received information related to the event and comparing the determined priority of the generated event to a priority of the contents being output. It is further contemplated that generating the bookmark includes determining whether the generated event is related to the electronic device, the determination based on the received information related to the event.

It is contemplated that the electronic device and the different electronic device each are a computer, a television, a cellular phone, a home appliance, a digital broadcasting terminal, a personal digital assistant (PDA), a portable multimedia player (PMP), a navigation system or a mobile Internet device. It is further contemplated that the electronic device and the different electronic device use different protocols and receiving the information in the electronic device includes protocol conversion.

In another aspect of the present invention, an electronic device for generating a bookmark related to contents that are output by the electronic device is provided. The electronic device includes an output unit configured to output the contents from the electronic device, a receiving unit configured to receive information related to an event generated in a different electronic device while the contents are output by the output unit and a controller configured to generate the bookmark that is related to the contents and control the output unit to output information related to the generated bookmark.

It is contemplated that the controller is further configured to control the output unit to no longer output the contents upon generating the bookmark. It is further contemplated that the controller is further configured to control the output unit to resume output of the contents based on the generated bookmark upon receiving information related to termination of the event.

It is contemplated that the controller is further configured to store at least the contents or the information related to the generated bookmark while controlling the output unit to no longer output the contents and obtain at least the stored contents or the stored information related to the generated bookmark when controlling the output unit to resume output of the contents. It is further contemplated that the device further includes a storage unit configured to store information, where the controller is further configured to control the storage unit to store at least the contents or the information related to the generated bookmark while controlling the output unit to no longer output the contents.

It is contemplated that the controller is further configured to transfer the contents to a server for storage while controlling the output unit to no longer output the contents. It is further contemplated that the controller is further configured to determine if time information related to the contents is available, store the contents if the time information is not available and not store the contents if the time information is available. It is further contemplated that determining if time information related to the contents is available includes determining if a reproduction state variable is received.

It is contemplated that the electronic device further includes a display unit configured to at least display information and the controller is further configured to control the display unit to provide a user interface upon receiving the information related to termination of the event and control the output unit to resume output of the contents according user input received via the user interface. It is further contemplated that the controller is further configured to delete the generated bookmark upon completion of the output of the contents based on the generated bookmark.

It is contemplated that the controller is further configured to generate the bookmark by determining a priority of the generated event based on the received information related to the event and comparing the determined priority of the generated event to a priority of the contents being output. It is further contemplated that the controller is further configured to generate the bookmark by determining whether the generated event is related to the electronic device, the determination based on the received information related to the event.

It is contemplated that the electronic device and the different electronic device each are a computer, a television, a cellular phone, a home appliance, a digital broadcasting terminal, a personal digital assistant (PDA), a portable multimedia player (PMP), a navigation system or a mobile Internet device. It is further contemplated that the electronic device and the different electronic device use different protocols and receiving the information in the electronic device includes protocol conversion.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIG. 1 illustrates a system environment according to the present invention.

FIG. 2 illustrates a network according to an embodiment of the present invention.

FIG. 3 is a block diagram of a first TV according to an embodiment of the present invention.

FIG. 4 is a flowchart illustrating a method of controlling an electronic device according to an embodiment of the present invention.

FIG. 5 is a flowchart illustrates a method of joining electronic devices in a local network according to an embodiment of the present invention.

FIG. 6 illustrates examples of priorities of generated events and contents reproduction according to the present invention.

FIG. 7 illustrates user designation of electronics devices according to an embodiment of the present invention;

FIG. 8 is a flowchart illustrating a method of generating a bookmark according to an embodiment of the present invention.

FIG. 9 illustrates a time shift function according to the present invention.

FIG. 10 is a flowchart illustrates a method of storing contents received using the time shift function illustrated in FIG. 9.

FIG. 11 illustrates exemplary bookmarks generated according to an embodiment of the present invention.

FIG. 12 illustrates a user interface according to an embodiment of the present invention.

FIG. 13 is a flowchart illustrating a method of generating a bookmark and using the generated bookmark according to an embodiment of the present invention.

FIG. 14 is a flowchart illustrating a method of generating a bookmark and using the generated bookmark according to another embodiment of the present invention.

### DETAILED DESCRIPTION OF THE PREFERRED EMBODIMENTS

The above-described objects, characteristic and advantages of the present invention will be more apparent through the attached drawings and the following detailed description. Hereinafter, the present invention will be described in detail by explaining preferred embodiments of the invention with reference to the attached drawings. Like reference numerals in the drawings denote like elements. In the following description of the present invention, a detailed description of known functions and configurations incorporated herein will be omitted when it may obscure the subject matter of the present invention.

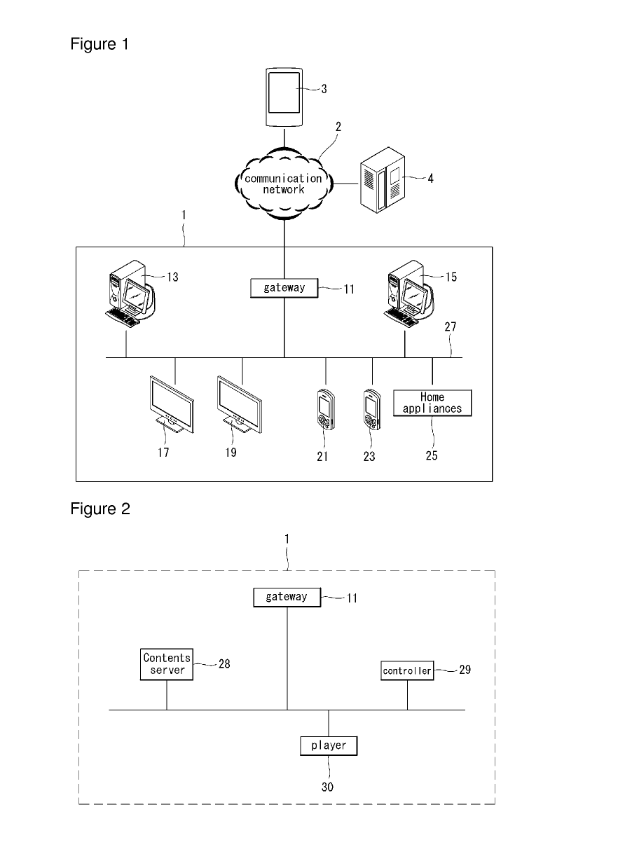

FIG. 1 illustrates a system environment according to the present invention. The system environment may include a network 1, a communication network 2, an external electronic device 3, and an external server 4.

The network 1 may be a network to which electronic devices 13, 15, 17, 19, 21, 23, 25 are linked. The network 1 may be a local network. The network 1 may include a home network and a social network, for example. For convenience of explanation, the network 1 is assumed to be a home network.

A common protocol or different protocols may be used for communication between electronic devices 13, 15, 17, 19, 21, 23, 25 in the network 1. For example, the protocol may include at least universal plug and play (UPnP), digital living network alliance (DLNA), living network control protocol (LNCP), or power line communication (PLC). The protocol used in the network 1 is not limited to these protocols. When two of more of the electronic devices 13, 15, 17, 19, 21, 23, 25 use different protocols, the electronic devices can communicate with each other through protocol conversion.

The network 1 may include a gateway 11, electronic devices 13, 15, 17, 19, 21, 23, 25 and a transmission medium 27. The electronic devices may include first and second computers 13 and 15, first and second TVs 17 and 19, first and second cellular phones 21 and 23, and home appliances 25, for example. Furthermore, the network 1 may further include various devices such as digital broadcasting terminals, personal digital assistants (PDA), portable multimedia players (PMP), navigation systems, or mobile Internet devices (MID) in addition to the electronic devices. The number of electronic devices included in the network 1 may be arbitrary.

The gateway 11 may have a function for accessing the communication network 2. The first and second computers 13 and 15 may have functions of controlling the network 1, playing contents and storing contents. A computer having better performance amongst the first and second computers 13 and 15 may be designated as a main computer.

The first and second TVs 17 and 19 may have a function of playing contents. The first and second TVs 17 and 19 may include an analog TV and/or a digital TV.

The first and second cellular phones 21 and 23 may include various mobile terminals. The home appliances may include various devices such as a doorbell, a refrigerator, a washing machine, or a microwave oven.

The transmission medium 27 may link electronic devices of the same type or different types to the gateway 11. The transmission medium 27 may include wired and wireless media. For example, the transmission medium 27 may be a power line, WI-FI or Bluetooth™.

Although FIG. 1 illustrates only a single transmission medium 27, the electronic devices 13, 15, 17, 19, 21, 23, 25 may be linked through different transmission media. The electronic devices connected to different transmission media may use a common protocol. In addition, when the electronic devices use different protocols, they can communicate with each other by adapting the different protocols

The communication network 2 may provide a function of linking the network 1 to an external network. The external network may include the external electronic device 3 and the external server 4, for example. The communication network 2 may include wired/wireless Internet, a mobile communication network, or a broadcasting network.

The external electronic device 3 may be a device that is not directly linked to the network 1. For example, the external electronic device 3 may be a device that is not directly linked to the network 1 but can be connected to the network such as the first TV 17 linked through the communication network 2.

Furthermore, the external electronic device 3 may remotely control the network 1 or receive a remote control signal from the network 1. For example, the external electronic device 3 may be a mobile terminal that is not linked to the network 1, such as an out-of home mobile terminal.

The external server 4 may provide contents to the network 1. For example, the external server 4 provides real-time contents and/or contents stored in the external server to the network 1 through the communication network 2. Furthermore, the external server 4 may provide contents in a streaming mode and/or a downloading mode. The external sever 4 may include a broadcasting station.

FIG. 2 illustrates a network 1 according to an embodiment of the present invention. Electronic devices 13, 15, 17, 19, 21, 23, 25 in the network 1 may be classified by function. As illustrated in FIG. 2, the electronic devices in the network may be classified as a contents server 28, a controller 29, or a player 30.

The contents server 28 may store contents and manage the stored contents. The contents server 28 may receive various commands from the controller 27 and execute the received commands. If the contents server 28 receives a play command, for example, it can search for contents to be played and provide the searched contents to the player 30.

The contents server 28 can include any electronic device that stores contents. For example, the contents server 28 may include the first and second computers 13 and 15, the first and second TVs 17 and 19, the first and second cellular phones 21 and 23, and the home appliances 25 illustrated in FIG. 1.

The controller 29 may have a function of controlling the contents server 28 and/or the player 30. The controller 29 can include any electronic device having a control function. For example, the controller 29 may include the first and second computers 13 and 15, the first and second TVs 17 and 19, the first and cellular phones 21 and 23, and the home appliances 25.

The player 30 may have a function of outputting contents. The player 30 can include any electronic device having a function of outputting contents. For example, the player 30 may include the first and second computers 13 and 15, the first and second TVs 17 and 19, the first and second cellular phones 21 and 23, and the home appliances 25.

The electronic devices 13, 15, 17, 19, 21, 23 and 25 may correspond to at least the server 28, the controller 29, or the player 30 according to their function. If the first computer 13 has functions of storing, controlling and outputting contents, it may correspond to the contents server 28, the controller 29, and the player 30.

The first TV 17 will now be explained in more detail with reference to the attached drawings. In the following description, suffixes “module” and “unit” are given to components of a mobile terminal in consideration of only facilitation of description and do not have different meanings or functions. The second TV 19 may have the same configuration as the first TV 17.

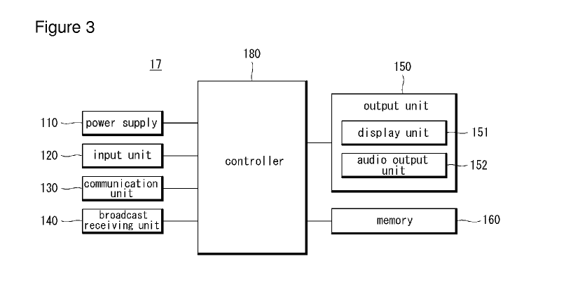

FIG. 3 is a block diagram of the first TV 17 according to an embodiment of the present invention. The first TV 17 may include a power supply 110, an input unit 120, a communication unit 130, a broadcast receiving unit 140, an output unit 150, a memory 160, and a controller 180. The components of the first TV 17 are not limited to these elements and the first TV may include only some of these elements or further include other components in addition to these elements.

The power supply 110 receives external power and/or auxiliary power and provides power required to operate the components of the first TV 17. A user generates input data for controlling the operation of the first TV 17 through the input unit 120.

The communication unit 130 may include at least one module for allowing the first TV 17 to communicate with other electronic devices. The communication unit may use wired communication methods, such as Ethernet and PLC, or wireless communication methods, such as Zigbee™.

The controller 180 may process data received through the communication unit 130. The broadcast receiving unit 140 receives broadcasting signals and/or broadcasting associated information from an external broadcasting management server through a broadcasting channel.

The broadcasting channel may include a satellite channel and/or a terrestrial channel. The broadcasting management server may correspond to a server that generates and transmits broadcasting signals and/or broadcasting associated information or a server that receives previously generated broadcasting signals and/or broadcasting related information and transmits the received broadcasting signals and/or broadcasting related information to terminals such as the first and second TVs 17 and 19. The broadcasting signals and/or broadcasting associated information received through the broadcast receiving unit 140 may be stored in the memory 160

The first TV 17 may not include the broadcasting receiving unit 140. The broadcast receiving unit 140 may be provided as an element independent of the first TV and may communicate with the first TV in a wired/wireless manner. The controller 180 may process data received through the broadcast receiving unit 140. For example, the broadcast receiving unit 140 may be included in a set-top-box (not shown) connected to the first TV 17 and the first TV may receive data from the set-top-box through the communication unit 130.

The output unit 150 generates a visual, auditory or tactile output and may include a display unit 151 and an audio output unit 152. In addition, the output unit 150 may further include a haptic module (not shown) for generating the tactile output, as such as vibration.

The display unit 151 displays information processed in the first TV 17. The display unit 151 may include a liquid crystal display, a thin film transistor-liquid crystal display, an organic light-emitting diode, a flexible display, or a 3D display. The first TV 17 may include two or more display units 151.

The audio output unit 152 outputs audio data received from an external device or generated by the first TV 17. The audio output unit 152 may output audio signals related to functions executed in the first TV 17. The audio output unit 152 may include a speaker or a buzzer. Furthermore, the audio output unit 152 may output sound through an earphone jack. A user can connect an earphone to the earphone jack and hear the sound.

The memory 160 may store programs for the operation of the controller 180 and temporarily or permanently store input/output data, such as audio data, still images, moving images, and broadcasting related information. Contents described in this document may include the above data.

The memory 160 may include at least a flash memory, a hard disc, a multimedia card micro type, a card type memory (for example, SD or XD memory), random access memory (RAM), static RAM (SRAM), read-only memory (ROM), electrically erasable programmable read-only memory (EERROM), programmable read-only memory (PROM), a magnetic memory, a magnetic disc, or an optical disc. The memory 160 may be provided as an element independent of the first TV 17. For example, a digital video recorder (DVR) independent of the first TV 17 may function as the memory 160.

The controller 180 controls the overall operation of the first TV 17. For example, the controller 180 performs control and processing relating to broadcasting receiving, broadcasting recording, and Internet access.

For a hardware implementation, the embodiments of the present invention can be implemented using at least application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or electrical units for executing functions.

For software implementation, embodiments such as procedures or functions can be implemented with a separate software modules executing at least one function or operation. Software codes can be implemented according to a software application written in an appropriate software language. Furthermore, the software codes can be stored in the memory 160 and executed by the controller 180.

The other electronic devices 13, 15, 19, 21, 23, 25 may include all or some components of the first TV 17 according to the functions of the electronic devices. Furthermore, the electronic devices 13, 15, 17, 19, 21, 23, 25 may include additional components to achieve unique functions. For example, the first and second cellular phones 21 and 23 may include a mobile communication module to access mobile communication networks.

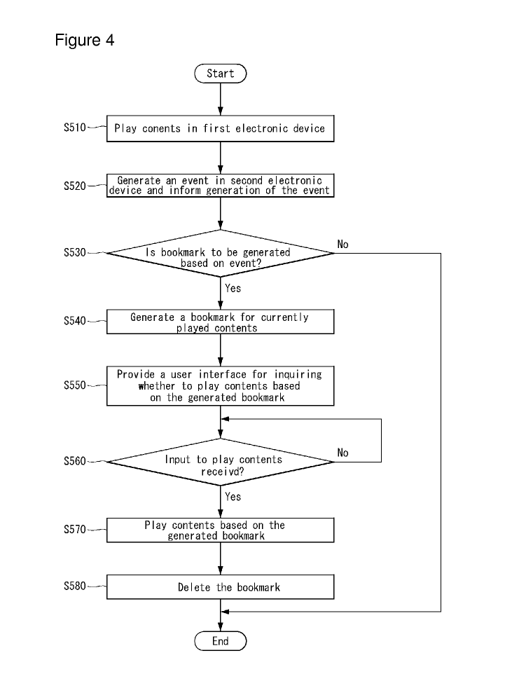

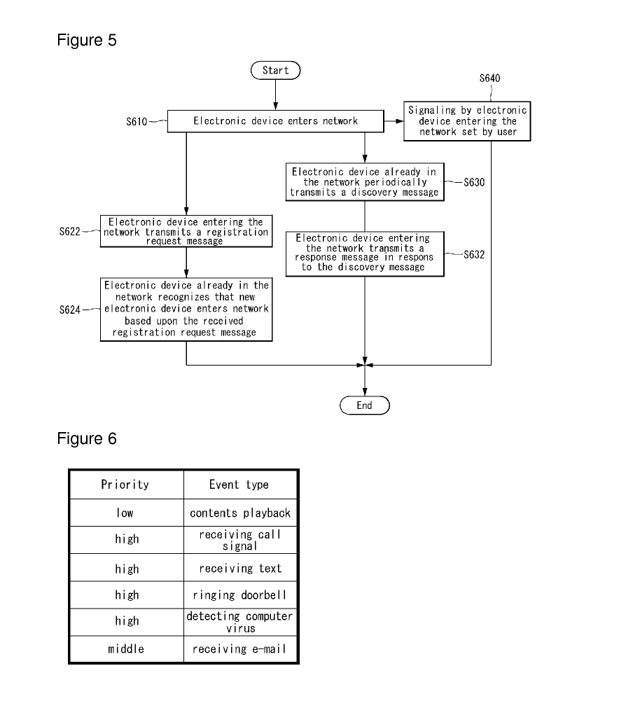

A method of automatically generating a bookmark for contents being played by an electronic device when an event is generated in another electronic device while the electronic device is playing the contents will now be explained. FIG. 4 is a flowchart illustrating a method of controlling an electronic device according to an embodiment of the present invention. The method of controlling an electronic device illustrated in FIG. 4 is described with reference to FIGS. 5 through 12.

The method of controlling an electronic device shown in FIG. 4 may be performed in the environment including the electronic devices explained with reference to FIGS. 1-3. Referring to FIG. 4, the method of controlling an electronic device is implemented by playing contents (S510), generating an event in an electronic device different from the electronic device currently playing the contents and informing the generated event (S520), determining whether to generate a bookmark when the event is generated (S530), generating a bookmark for the currently played contents (S540), providing a user interface for inquiring about whether to play the contents based on the generated bookmark (S550), receiving a user input to play the content (S560), playing the contents based on the generated bookmark (S570), and deleting the bookmark (S580).

The electronic devices 13, 15, 17, 19, 21, 23 and 25 may play contents (S510). It is assumed that the first TV 17 plays contents. However, the present invention is not limited to a specific device.

The first TV 17 may play the contents through the output unit 150. In this manner, a user can watch various contents including broadcasting and multimedia contents through the output unit 150

Contents described in this document may include various contents. For example, the contents may include multimedia contents, texts, still images, moving images, animation, broadcasting contents, and applications.

The first TV 17 may obtain the contents from various sources. For example, the first TV 17 can obtain the contents from the memory 160 or from other electronic devices 3, 4, 13, 15, 19, 21, 23 and 25.

An event may be generated in the other electronic devices 3, 4, 13, 15, 19, 21, 23 and 25 while the first TV 17 is outputting the contents and the electronic device generating the event may inform the other electronic devices that the event is generated (S520). The electronic device generating the event may transmit information related to the event to the other electronic devices.

The electronic device generating the event may transmit the event related information to electronic devices that satisfy predetermined standards. The predetermined standards may include whether an electronic device belongs to the local network to which the electronic device generating the event belongs or whether an electronic device belongs to the user of the electronic device generating the event.

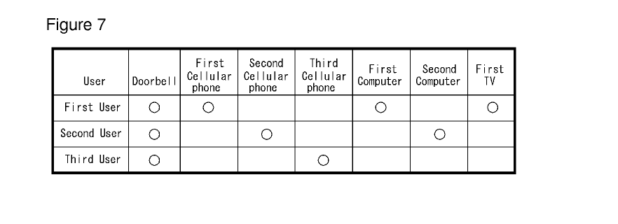

A method of determining whether an electronic device belongs to the local network to which the electronic device generating the event belongs will be explained with reference to FIG. 5. A method of determining whether an electronic device belongs to the user of the electronic device generating the event, which is one of the predetermined standards, will be explained with reference to FIG. 7.

As illustrated in FIG. 5, the electronic device generating the event may detect an electronic device belonging to the same local network. FIG. 5 is a flowchart illustrating a method of an electronic device joining a local network according to an embodiment of the present invention by which the electronic devices 13, 15, 17, 17, 21, 23 and 25 included in the local network 1 may recognize joined electronic devices.

It is assumed that the first cellular phone 21 is the electronic device that enters the network 1 from outside the network and the network is managed by the first TV 17 for convenience of explanation. However, the network 1 can be managed by other electronic devices and a different electronic device may join the network.

The first cellular phone 21 enters the network 1 from outside of the network (S610). If the network 1 is a home network, the entry of the first cellular phone 21 can correspond to the user of the first cellular phone returning home and entering the home network. The first TV 17 can determine whether the first cellular phone 21 enters the network 1 through various methods.

The first cellular phone 21 may periodically transmit a registration request message (S622). The registration request message may be transmitted to the communication network 2 used in the network 1. The registration request message may include at least one the device identifier, description information or a service list of the first cellular phone 21.

The device identifier may be an identifier for identifying the first cellular phone 21. The description information may provide product information related to the first cellular phone 21. The service list may include a list of services provided by the first cellular phone 21.

The registration request message may further include user information of the first cellular phone 21. The user information may provide information for identifying the user of the first cellular phone 21. The function of the user information will be described in detail later.

The first TV 17 receives the registration request message (S624) and the controller 180 of the first TV 17 determines whether the first cellular phone 21 is an electronic device newly entering the network 1 based on the registration request message (S624). For example, the controller 180 of the first TV 17 can determine that the first cellular phone 21 is an electronic device newly entering the network 1 when the device identifier of the first cellular phone 21 is not included in the network.

The controller 180 of the first TV 17 may store information about the first cellular phone 21, such as the device identifier, the description information, and the service list. The controller 180 of the first TV 17 may transmit the device identifier, the description information, and the service list of the first TV 17 to the first cellular phone 21. Accordingly, the first TV 17 and the first cellular phone 21 can recognize each other in the network 1, whereby the first TV 17 can determine that the first cellular phone 21 is included in the local network and the first cellular phone 21 can determine that the first TV 17 is included in the same local network.

The first TV 17 may periodically transmit a discovery message through the communication unit 130 to check electronic devices linked to the network 1 (S630). For example, the discovery message may include at least the device identifier, the description information, or the service list of the first TV 17.

The first cellular phone 21 that newly enters the network 1 receives the discovery message (S632). The first cellular phone 21 may be linked to the network 1 based on the received discovery message. For example, the first cellular phone 21 may enter the network 1 and store the information about the first TV 17 when the device identifier of the first TV included in the discovery message is not stored in the first cellular phone.

The first cellular phone 21 may transmit a response message to the first TV 17 in response to the received discovery message (S632). The response message transmitted to the first TV 17 may include at least the device identifier, the description information, or the service list of the first cellular phone 21. Accordingly, the first TV 17 and the first cellular phone 21 can determine that they belong to the same local network 1. The user of the first cellular phone 21 may set the first cellular phone to transmit signals indicating that the first cellular phone is included in the network 1 (S640).

The electronic device generating the event may detect the other electronic devices belonging to the network 1 and transmit the event related information to the other electronic devices through the method illustrated in FIG. 5. When an event is generated in the first cellular phone 21, for example, information related to the event can be transmitted to the electronic devices belonging to the network 1 to which the first cellular phone 21 belongs.

The event may be related to the function of the electronic device generating the event. The event may correspond to receiving a call signal or receiving a text when the electronic device generating the event is a cellular phone and may correspond to receiving e-mail or detecting a computer virus when the electronic device generating the event is a computer. Furthermore, when the electronic device generating the event is a doorbell, the event may be ringing the doorbell. The present invention is not limited to these examples.

Receiving a call signal may correspond to the first cellular phone 21 receiving a call signal while the first TV 17 is playing the contents. Ringing a doorbell may correspond to a doorbell, which is an example of the home appliances 25 included in the network 1, generating a ring signal while the first TV 17 is playing the contents.

It is assumed that the first TV 17 obtains information related to an event generated by another electronic device included in the network 1 in the current embodiment of the present invention. The first TV 17 may belong to the same local network as the electronic device generating the event or belong to the user of the electronic device generating the event.

The event related information may include information about the generated event. For example, the event related information may include at least the event type, event generating time, event priority, or identifier of the electronic device generating the event.

The event type may represent the event generated in the electronic device. The event generating time may represent when the event is generated. The event priority may represent the importance of the event. The identifier of the electronic device generating the event may correspond to information for identifying the electronic device generating the event.

The controller 180 of the first TV 17 may inform the user that the event is generated via the output unit 150 based on the received event related information. Accordingly, the user can be immediately made aware of the generation of the event. For example, the controller 180 can output at least the event type, the event generating time, the event priority, or identifier of the electronic device generating the event via the output unit 150.

Referring again to FIG. 4, it may be determined whether a bookmark is to be generated based on a bookmark generation standard when the event is generated (S520). The bookmark generation standard may be determined by at least the electronic device currently outputting the contents, the electronic device generating the event, or the electronic device managing the network 1. It is assumed that the first TV 17 that is playing the contents and receives the event related information from the electronic device generating the event determines the bookmark generation standard.

The controller 180 of the first TV 17 determines whether to generate the bookmark for the currently output contents based on the bookmark generation standard when the event is generated (S530). The bookmark generation standard may be determined according to at least whether the electronic device generating the event and the electronic device currently outputting the contents are designated to the same user, whether the electronic device generating the event and the electronic device currently outputting the contents belong to the same local network, or whether the priority of the event is higher than the priority of the contents playback.

The controller 180 may output a control signal for bookmarking the contents when the bookmark generation standard is satisfied. The control signal is used to automatically generate a bookmark for contents being played when an event is generated in an electronic device different from the electronic device playing the contents (S540).

The control signal may include the event related information. The control signal may further include information required to generate the bookmark. The information required to generate the bookmark will be explained later.

The controller 180 may transmit the control signal to another electronic device currently outputting contents. If there are multiple electronic devices currently outputting contents, the controller 180 may generate bookmarks for the currently output contents of the multiple electronic devices. Furthermore, the controller 180 may transmit the control signal to the other electronic devices currently outputting the contents based on at least whether the other electronic devices belong to the local network to which the electronic device generating the event belongs or whether the other electronic devices belong to the user of the electronic device generating the event.

FIG. 5 illustrates the bookmark generation standard based upon whether the electronic device generating the event and the electronic device currently outputting the contents belong to the same local network 1. Priorities of the event and playback of the contents will be described with regard to FIG. 6. The controller 180 may determine whether the priority of the event is higher than the priority of the contents playback according to predetermined priorities. Events that are more important than playing the contents can include any event that is considered by the user to be more important than watching the contents.

FIG. 6 illustrates exemplary priorities of events and contents playback. As illustrated in FIG. 6, receiving a call signal, receiving a text, ringing a doorbell, detecting a computer virus, and receiving e-mail have middle or higher priorities, while contents playback has a low priority. All the events illustrated in FIG. 6 have priorities higher than the contents playback.

The event generated in the electronic device different from the electronic device currently outputting the contents can include any event that makes the user stop watching the contents in order to handle the event. For example, the event may include finishing a washing operation, detecting gas leakage or detecting fire.

The event type and the priority of contents playback may be changed by the user. For example, the user can set the importance of the mail receiving event such that the priority of the mail receiving event is lower than the priority of the contents playback when the user determines that watching the currently played contents is more important than receiving the mail.

When the received information related to the event includes the event type, the controller 180 may compare the priority of the event with the priority of the contents playback according to FIG. 6 to determine whether the priority of the event is higher than the priority of the contents playback. When the received information related to the event includes the event priority, the controller 180 may compare the priority of the event with the priority of the contents playback to determine whether the priority of the event is higher than the priority of the contents playback.

The bookmark generation standard according to whether the electronic device generating the event and the electronic device currently outputting the contents are designated to the same user will be explained with respect to FIG. 7. The bookmark generation standard can be applied to the standards for transmitting the event related information and transmitting the control signal for generating a bookmark.

FIG. 7 illustrates electronic devices allocated to users according to an embodiment of the present invention. Electronic devices may be designated to only a specific user or multiple users. As illustrated in FIG. 7, a doorbell, a first cellular phone, a first computer, and first TV may be allocated to a first user and a doorbell, a second cellular phone, and a second computer may be allocated to a second user. A doorbell and third cellular phone third may be allocated to a third user.

When an event is generated in the first cellular phone of the first user, bookmarks may be generated for contents currently output from the first computer and the first TV designated to the user of the first cellular phone. Since the event generated in the first cellular phone is related to the first user, the event may be irrelevant to the second user.

When the first user receives a call signal through the first cellular phone, the first user cannot watch contents through the first computer and the first TV while receiving the call signal. Therefore, it is required to generate bookmarks for contents currently played by the first computer and the first TV. However, even when the first user receives a call through the first cellular phone, there is no need to generate a bookmark for contents currently played by the second computer since the second computer is not used by the first user.

The controller 180 may recognize a user through a camera (not shown) included in the first TV 17. The controller 180 may check electronic devices allocated to the recognized user based on the previously disclosed user information.

The controller 180 may generate the bookmark for the currently played contents according to the control signal when the bookmark generation standard is satisfied (S540). The controller 180 may end the corresponding operation when the bookmark generation standard is not satisfied.

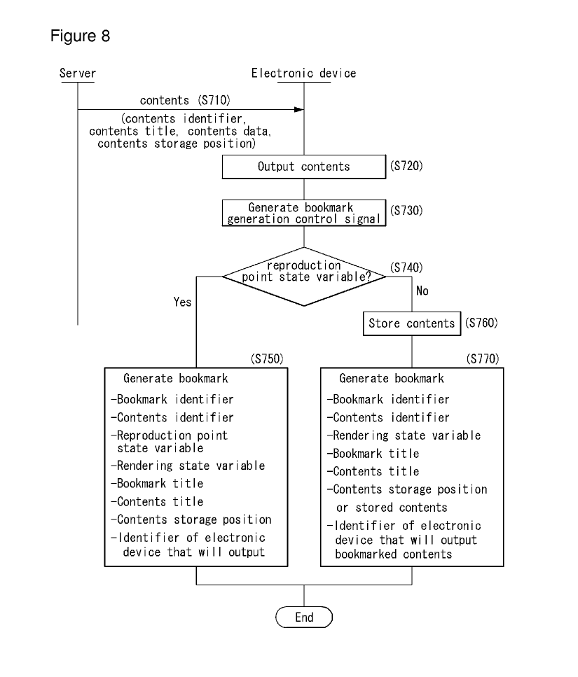

A method of generating a bookmark according to an embodiment of the present invention will now be explained with reference to FIG. 8. FIG. 8 is a flowchart showing the method of generating a bookmark according to an embodiment of the present invention.

As illustrated in FIG. 8, the first TV 17 may generate a bookmark according to the control signal for generating a bookmark. It is assumed that the electronic device shown in FIG. 8 corresponds to the first TV 17 and the server illustrated in FIG. 8 corresponds to an electronic device storing contents.

The first TV 17 may receive contents from the server (S710). The contents may include at least contents data, a contents title, a contents identifier, or information about the position in which the contents are stored (referred to as contents storage position information hereinafter).

The contents data may be a media file or a media stream that can be reproduced by the first TV 17. As used herein, to play and output contents means to reproduce and output contents data.

The contents title, the contents identifier, and the contents storage position information may be metadata related to the contents data and may be transmitted to the first TV 17 together with the contents data or may be transmitted independent of the contents data. The contents title, the contents identifier, and the contents storage position information may be information used to generate a bookmark. The contents title, the contents identifier, and the contents storage position information will be described in detail later.

The first TV 17 may output the received contents through the output unit 150 (S720). The contents may be stored in the memory 160 of the first TV 17 or an electronic device independent of the first TV. When the contents are stored in the memory 160 of the first TV 17, the first TV simultaneously provides a server function and a player function.

The control signal for generating a bookmark for the contents currently played by the first TV 17 may be generated when an event is generated (S730). The first TV 17 may determine whether a state variable with respect to a reproduction point of the currently output contents can be obtained for generating a bookmark (S740) and the first TV 17 may generate a bookmark with respect to the contents depending on whether the reproduction point state variable can be obtained.

The reproduction point state variable may represent the quantity of contents that have been played. The reproduction point state variable will be described in detail later.

The first TV 17 may obtain the reproduction point state variable from metadata of the received contents or the first TV may request the server providing the contents to transmit the reproduction point state variable. When the contents are stored in the first TV 17, the first TV can obtain the reproduction point state variable from itself.

The first TV 17 may generate the bookmark when the first TV can obtain the reproduction point state variable (S750). The first TV 17 can directly generate the bookmark for the contents and instruct another electronic device, such as the electronic device providing the contents, to generate the bookmark.

The first TV 17 may generate the bookmark by obtaining or generating at least a contents title, a contents identifier, a bookmark title, a bookmark identifier, a reproduction point state variable, a rendering state variable, a contents storage position, or the identifier of an electronic device that will output the bookmarked contents. This information is not essential and the bookmark may include only some of the information or further include other information.

The contents title represents the title of the currently output contents. The controller 180 of the first TV 17 may obtain the contents title through the metadata of the contents, such as via the contents received (S710). The contents title may be obtained from an electronic program guide (EPG).

The contents identifier may be information for identifying the bookmarked contents. The contents identifier may designate the contents to be played when the contents are played based on the bookmark.

The controller 180 of the first TV 17 may obtain the contents identifier through various methods. For example, the controller 180 of the first TV 17 may obtain the contents identifier from the metadata of the currently output contents.

The controller 180 of the first TV 17 may arbitrarily generate the contents identifier. For example, when the contents identifier obtained through the metadata is identical to the contents identifier of other contents, the first TV 17 may generate the contents identifier such that when the contents identifier of contents received from an external device of the network 1 is identical to the contents identifier of contents of an internal device of the network 1, the first TV can generate a contents identifier for discriminating the contents from each other.

The controller 180 of the first TV 17 may generate the contents identifier based on at least the contents title, a contents file size, a contents creating date, or a contents serial number. When the title of the bookmarked contents is “superman,” for example, the controller 180 of the first TV 17 can use the contents title as the contents identifier.

The controller 180 of the first TV 17 may use at least the contents file size and the contents creating date to generate the contents identifier. The contents file size or the contents creating date can identify the bookmarked contents when there are contents having the same contents title as the bookmarked contents and a file different from the bookmarked contents.

The contents identifier includes the contents title, the file size of the bookmarked contents, and the bookmarked contents creating date. Therefore, the contents identifier can identify the bookmarked contents. For example, the contents identifier may include information “superman(contents title)//700,265,584 bytes(file size)//2010.08.07(creating date)” to identify the bookmarked contents. The controller 180 of the first TV 17 may obtain the contents title, the file size of the bookmarked contents, and the bookmarked contents creating date from tag data of the currently output contents.

The contents identifier may include a serial number given to each of the contents. For example, the serial number may be given by the electronic device that manages the network 1 and may be stored in the metadata of the contents. When new contents are discovered, the electronic device that manages the network 1 may allocate a new serial number to the new contents. Accordingly, it is possible to generate contents identifiers such that the contents identifier of contents of an internal device of the network 1 is different from the contents identifier of contents of an external device of the network.

The bookmark title corresponds to the title of the bookmark and may allow the user to conveniently search for the bookmark. The first TV 17 may receive the bookmark title from the user or generate the bookmark title according to a predetermined method.

For example, the controller 180 of the first TV 17 can arbitrarily generate the bookmark title based on the contents title. When the contents title is “superman” the bookmark title may be “superman(contents title)//2010.08.07(bookmark generating date)//05:20 PM(bookmark generating time).” This is an example of the bookmark title and can include any information that can provide convenience to the user when the user searches for the bookmark.

The bookmark identifier may be information for identifying the generated bookmark. The controller 180 of the first TV 17 may set the bookmark identifier as a unique value in the network 1. Accordingly, the bookmark can be differentiated from other bookmarks.

The bookmark identifier may be generated by the controller 180 of the first TV 17. The controller 180 of the first TV 17 may generate the bookmark identifier based on at least the contents identifier or the bookmark title.

For example, the bookmark identifier can be generated based on the contents identifier. The bookmark identifier can include at least bookmark generating date related information or information indicating that the bookmark was generated in the nth order on the bookmark generating date.

The bookmark identifier can have information on the bookmark generating date “2010.10.07” and information indicating that the bookmark was generated in the nth order on the bookmark generating date “2010.10.07,” which are included in the contents identifier “superman(contents title), 700,265,584 bytes(file size), 2010.08.07 (contents creating date).”

The controller 180 of the first TV 17 may inquire of another electronic device, for example, the electronic device that administrates the network 1, about the information indicating that the bookmark was generated in the nth order on the bookmark generating date. Furthermore, the controller 180 of the first TV 17 may use serial numbers of a bookmark generated in the network 1 to generate the bookmark identifier.

For example, if one hundred bookmarks have been generated in the network 1 up to a preset time, the controller 180 can increment the last serial number and use 101 as the serial number of the newly generated bookmark identifier. To achieve this, the controller 180 can obtain the serial number of the last generated bookmark in the network 1 to generate the new bookmark identifier such that the new bookmark identifier is unique in the network. The controller 180 of the first TV 17 may inquire of another electronic device, for example, the electronic device that manages the network 1, about the serial number of the last generated bookmark.

The reproduction point state variable may be information about a reproduction point that indicates the quantity of contents that have been played. The first TV 17 may obtain the reproduction point state variable from the received contents. Otherwise, the first TV 17 may obtain the reproduction point state variable from the server providing the contents by requesting the server to provide the reproduction point state variable.

For example, the reproduction point may be defined based on a contents play time and the number of frames of the contents and may be 00:29:39 seconds. This indicates that 29 minutes 39 seconds have elapsed from the starting point of the currently output contents. The reproduction point state variable may be 159 frames. This indicates that the bookmark is generated when 159th frame of the contents is reproduced.

The reproduction point state variable may include at least channel information or broadcasting time. For example, the reproduction point state variable may have a structure of “CH9(channel information)//14:13:00(broadcasting time).”

The rendering state variable may include information about the environment in which the contents are played. The rendering state variable can include any environment related to playback of the contents, such as brightness or volume. For example, the rendering state variable can include information of brightness of 8, volume of 10, and resolution of 800×600.

The controller 180 of the first TV 17 can obtain the rendering state variable for the playback environment of the contents and generate the bookmark in order to provide the same playback environment when the user plays the bookmarked contents later. The first TV 17 can obtain the rendering state variable from the first TV 17 currently outputting the contents.

The controller 180 of the first TV 17 can obtain the contents storage position through the metadata of the contents. The contents storage position may allow the bookmarked contents to be easily searched. The contents storage position may include at least a contents folder or the identifier of the electronic device in which the contents are stored.

When the contents currently output from the first TV 17 are stored in the memory 160 of the first TV 17, the contents storage position may correspond to “First TV(identifier of the electronic device storing the contents)//contents\(contents folder).” When the contents currently output from the first TV 17 are streamed from another electronic device included in the network 1, such as the second computer 15, the contents storage position can correspond to “Second computer//contents\.”

When the contents are received from an external server of the network 1, the contents storage position may be indicated as the address of the external server, such as the IP address of the external server. For example, the contents storage position can be “200.222.255.2 (IP address of the external server)//contents\.”

An electronic device that will output the bookmarked contents may correspond to an electronic device outputting the bookmarked contents when the contents are played based on the bookmark. The controller 180 of the first TV 17 may receive the identifier of the electronic device outputting the bookmarked contents from the user. The identifier of the electronic device outputting the bookmarked contents may be designated by the electronic device currently outputting the contents.

When the electronic device storing the bookmarked contents is different from the electronic device playing the bookmarked contents, the electronic device outputting the bookmarked contents provides information by which the electronic device storing the bookmarked contents can recognize the electronic device playing the bookmarked contents.

Referring again to FIG. 7, when the first TV 17 determines that the reproduction point state variable cannot be obtained (S740), the first TV 17 may store the contents (S760) and generate the bookmark (S770).

The first TV 17 cannot obtain the reproduction point state variable when the received contents correspond to a broadcasting signal, for example. The first TV 17 may store the received contents according to a time shift function.

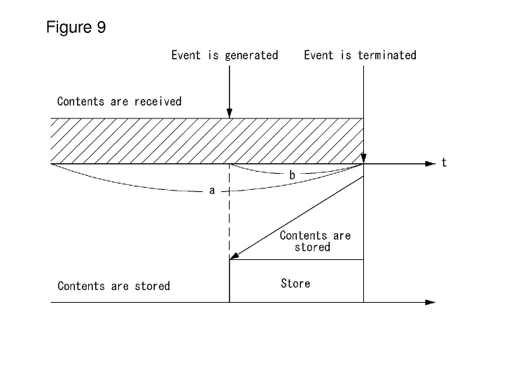

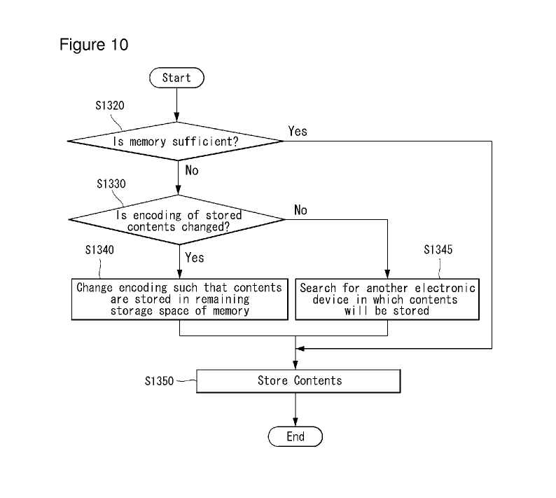

Storing the contents (S760) is described in detail with reference to FIGS. 9 and 10. FIG. 9 illustrates a time shift function, specifically a contents play table and a contents storage table. FIG. 10 is a flowchart illustrating a method of storing received contents using the time shift function according to an embodiment of the present invention.

As illustrated in FIG. 9, when an event is generated while contents are being played for a period “a”, the contents are stored for a period “b” from the event generating point. When the event is ended, the stored contents are continuously output so that the user can enjoy the contents seamlessly. A storage starting point illustrated in FIG. 9 may provide a function corresponding to the reproduction point state variable.

As illustrated in FIG. 10, the controller 180 of the first TV 17 checks whether the remaining storage space of the memory 160 is sufficient (S1320). The controller 180 determines that the remaining storage space of the memory 160 is insufficient when the remaining storage space of the memory is smaller than a predetermined size or smaller than a capacity required to store the rest of the contents that have not yet been received.

For example, if the quantity of the rest of the contents received from the external device of the network 1 corresponds to 20 minutes and the memory 160 cannot store the rest of the contents corresponding to 20 minutes, the controller 180 determines that the remaining storage space of the memory is insufficient. The quantity of the rest of the contents may be obtained by excluding the quantity of contents that have already been played from the entire play time of the metadata of the contents.

The controller 180 stores the entire contents in the memory 160 (S1350) when the controller 180 determines that the remaining storage space of the memory 160 is sufficient. The controller 180 determines whether encoding of the contents being received is changed (S1330) when the controller determines that the remaining storage space of the memory 160 is insufficient. The user may also arbitrarily determine whether the encoding is changed.

When the controller 180 determines that the encoding of the contents is changed, the controller 180 changes the encoding such that the contents can be stored in the remaining storage space of the memory 160 (S1340). The controller 180 may control the extent of the change of the encoding in stages such that the quantity of contents stored in the memory decreases as the remaining storage space of the memory 160 decreases. Encoding information may include at least resolution or a bit rate. The controller 180 may store the changed encoding information.

When the controller 180 determines that the encoding of the contents is not changed and the remaining storage space of the memory 160 is insufficient, the controller 180 searches for a substitute storage space for storing the contents (S1345).

For example, the controller 180 may transmit a command for inquiring of another electronic device about the remaining storage space of a memory of the other electronic device and determine the substitute storage space based on a response to the transmitted command. The controller 180 can determine an electronic device with a memory having the largest remaining storage space as the substitute storage space.

After either changing the encoding (S1340) or searching for a substitute storage space (S1345), the controller 180 stores the contents in the memory 160 or the storage space of the searched electronic device (S1350). In the embodiment illustrated in FIGS. 9 and 10, when the first TV 17 generates the bookmark with respect to the contents when the reproduction point state variable cannot be obtained, the first TV can store contents received after the generation of the bookmark is requested.

Referring again to FIG. 8, the first TV 17 generates the bookmark even when the first TV cannot obtain the reproduction point state variable (S770). The generation of the bookmark corresponds to the previously explained operation (S750) so that explanation is omitted.

The first TV 17 may obtain the contents title from the EPG. The first TV 17 may obtain other information used for generating the bookmark in a similar manner as previously explained.

The first TV 17 may generate the contents identifier for identifying the stored contents. For example, the first TV 17 can generate the contents identifier based on at least channel information or broadcasting time when the stored contents correspond to a broadcasting signal. The contents identifier may have a structure of “CH9(channel information)//14:13:00 (broadcasting time).”

The first TV 17 may obtain the storage position information of the stored contents. When the contents are stored in the first TV 17, the contents storage position may include information “First TV//contents\.” When the received contents are stored in a substitute electronic device, such as the first computer 13, the contents storage position may include information “First computer//contents\.” The first TV 17 may include the contents stored according to the time shift function in the generated bookmark.

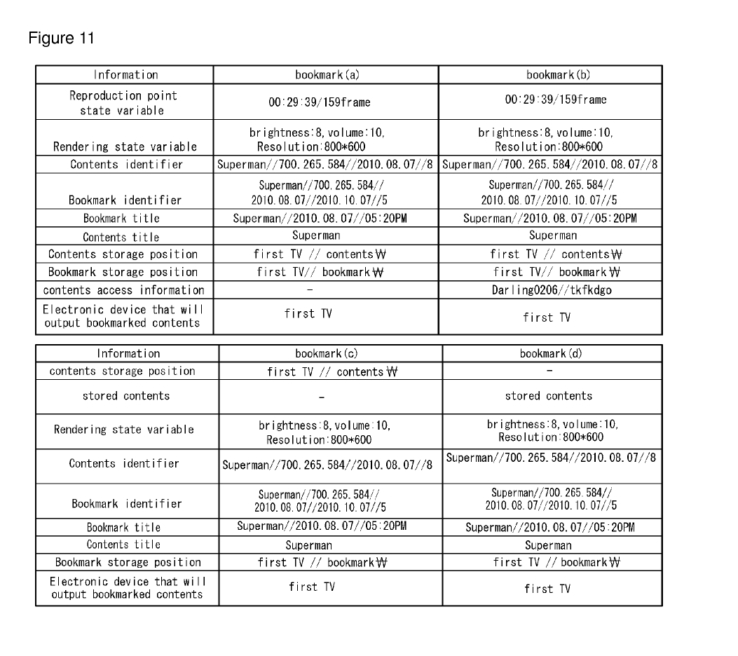

The bookmark with respect to the currently output contents can be generated according to the embodiment explained with reference to FIGS. 8-10. FIG. 11 illustrates exemplary bookmarks generated according to an embodiment of the present invention. Bookmark (a) and bookmark (b) illustrated in FIG. 11 are an exemplary structure of the generated bookmark when the reproduction point state variable can be obtained and bookmark (c) and bookmark (d) illustrated in FIG. 11 are an exemplary structure of the generated bookmark when the reproduction point state variable cannot be obtained.

The generated bookmark may include a bookmark storage position that represents the position where the bookmark is stored. For example, the bookmark storage position can represent a container of an electronic device that stores the generated bookmark such that the bookmark storage position represents where the generated bookmark is stored.

The bookmark storage position may include information about the identifier of the electronic device storing the bookmark and a folder storing the generated bookmark. If the electronic device storing the bookmark corresponds to the first TV 17, the information about the bookmark storage position may have a structure “First TV(identifier of the electronic device storing the bookmark)//bookmark\(folder storing the generated bookmark).”

The controller 180 may embed the received event related information in the generated bookmark. When the event related information is embedded in the generated bookmark, the user can be made aware of the reason for the generation of the bookmark.

The bookmark (a) illustrated in FIG. 11 may include at least a reproduction point state variable, a rendering state variable, a contents identifier, a bookmark identifier, a bookmark title, a contents title, a contents storage position, a bookmark storage position, or the identifier of an electronic device that will output bookmarked contents. The bookmark (b) illustrated in FIG. 11 may include contents access information as well as at least a reproduction point state variable, a rendering state variable, a contents identifier, a bookmark identifier, a bookmark title, a contents title, a contents storage position, a bookmark storage position, or the identifier of an electronic device that will output bookmarked contents.

The contents access information may include information required for the controller 180 to access the contents. For example, the contents access information may include at least an ID and password required to access the contents server 28 and the external server 4. For example, the contents access information may include “Darling0206(ID)//tkfkdgo(password).”

The contents access information automatically accesses the contents server 28 and/or the external server 4 when the user wants to enjoy the contents based on the generated bookmark. The contents access information may be encoded such that people other than the user cannot see the contents access information. The controller 180 of the first TV 17 may obtain the contents access information via a user input, for example.

The bookmarks (a), (b), (c) and (d) illustrated in FIG. 11 may further include contents encoding information. The contents encoding information may represent how the contents are encoded. For example, the contents encoding information may include at least a bit rate or resolution. The function of the contents encoding information will be described later.

The bookmarks (a), (b), (c) and (d) illustrated in FIG. 11 may further include information related to the generation of the bookmark. For example, the bookmarks (a), (b), (c) and (d) may further include at least bookmark generating time or the identifier of the electronic device generating the bookmark. The information included in bookmarks (a), (b), (c) and (d) may be used as information provided to the user via a user interface that will be described later.

The controller 180 of the first TV 17 may determine where the generated bookmark is stored. For example, the controller 180 of the first TV 17 can store the bookmark in the memory 160 of the first TV 17 or the electronic device storing the currently output contents. Furthermore, the controller 180 of the first TV 17 may store the bookmark in an electronic device designated by the user.

If the bookmark is stored in the electronic device storing the currently output contents, the controller 180 detects the electronic device storing the currently output contents based on the contents storage position and stores the bookmark in the detected electronic device. The controller 180 of the first TV 17 may store the bookmark in the electronic device that manages the network 1 such that bookmarks generated in the network are managed by the electronic device that manages the network in an integrated manner. The controller 180 of the first TV 17 may store the bookmark identifier and the bookmark storage position in the memory 160 of the first TV in order to link the bookmark when the bookmark is stored in a place other than the memory 160.

The controller 180 of the first TV may adjust the rendering state variable of the currently output contents and, at the same time, generate the bookmark when the event is generated. For example, the controller 180 can stop playing the currently output contents or mute the contents when the event is generated. Accordingly, power consumed to output the contents can be saved.

Referring again to FIG. 4, a user interface for inquiring about whether to play the contents based on the generated bookmark may be provided (S550). For example, the controller 180 of the first TV 17 may provide the user interface for inquiring about whether to play the contents using the generated bookmark.

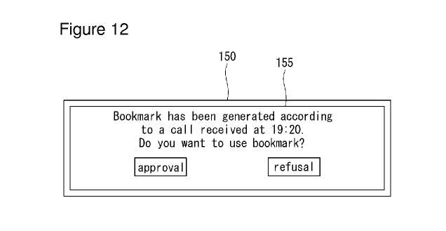

The controller 180 of the first TV 17 may provide a user interface 155 via output unit 150 for confirming whether to use the bookmark as shown in FIG. 12. The controller 180 of the first TV 17 may provide the user interface 155 when the event is terminated or after the lapse of predetermined amount of time after the event is generated.

When the controller 180 of the first TV 17 receives an event termination message via the output unit 150 from the electronic device that generated the event, the controller 180 can obtain the event termination time. For example, the event termination time may correspond to a call termination time, an e-mail confirmation time, or a virus elimination time.

The predetermined time elapsing from when the event is generated may be set according to the event type. For example, the predetermined time may correspond to a time required for the user to open a door when the event corresponds to ringing a doorbell. The predetermined time may be set by the user.

The user interface 155 may include at least the previously disclosed bookmark related information or the event related information. For example, the user can confirm the contents related to the generated bookmark based on the contents title included in the bookmark related information. Furthermore, the user can recognize the electronic device that generated the event and caused the generation of the bookmark based on the identifier of the electronic device generating the event that is included in the event related information.

When the user selects the “approval” icon via the user interface 155 illustrated in FIG. 12, the controller 180 replays the contents based on the stored bookmark (S570). For example, the controller 180 of the first TV 17 can output bookmarked contents through the output unit 150 based on the bookmarks (a), (b), (c) or (d) illustrated in FIG. 11 when the generated bookmark is stored in the memory 160 of the first TV. Output of the bookmarked contents when the generated bookmark is stored in an electronic device other than the first TV 17 will be described later.

When the controller 180 of the first TV 17 plays the contents based on bookmark (a) illustrated in FIG. 11, the controller can obtain the bookmarked contents based on whether the bookmarked contents are stored in the memory 160 of the first TV or in an electronic device other than the first TV. The controller 180 of the first TV 17 may obtain information about the electronic device storing the bookmarked contents based on the contents storage position information included in the bookmark. Accordingly, the first TV 17 can output the bookmarked contents through the output unit 150 according to the event in order to allow the user to watch the contents seamlessly

If the bookmarked contents are stored in the memory 160 of the first TV 17, the controller 180 of the first TV may search for the bookmarked contents based on the identifier of the bookmarked contents and output the bookmarked contents through the output unit 150 based on at least the reproduction point state variable or the rendering state variable. If the bookmarked contents are stored in one of the electronic devices 3, 13, 15, 19, 21, 23 and 25, the controller 180 of the first TV 17 may search for the electronic device storing the bookmarked contents based on the contents storage position and request the searched electronic device to provide the bookmarked contents.

The controller 180 may transmit the contents identifier to the electronic device storing the bookmarked contents to request the electronic device to provide the bookmarked contents. Furthermore, the controller 180 may transmit the reproduction point state variable to the electronic device storing the bookmarked contents to play the bookmarked contents.

The electronic device storing the bookmarked contents may search for the bookmarked contents based on the contents identifier received from the first TV 17. Furthermore, the electronic device storing the bookmarked contents may transmit the searched bookmarked contents to the first TV 17 based on the reproduction point state variable received from the first TV.

The controller 180 of the first TV 17 may output the received contents through the output unit 150 based on the rendering state variable. In addition, the controller 180 of the first TV 17 may play the contents based on bookmark (b) illustrated in FIG. 11. It is assumed that the bookmarked contents are stored in the external server 4 of the network 1 in the following description.

To play the contents stored in the external server 4 of the network 1 based on bookmark (b) illustrated in FIG. 11, the controller 180 of the first TV 17 may obtain the address of the server storing the bookmarked contents based on the contents storage position. When the controller 180 obtains the address of the server 4, the controller may transmit an access request to the server. The controller 180 may transmit the access information to the server 4 in order to access the server. The controller 180 of the first TV 17 can access the server 4 by transmitting the access information to the server without requiring a log-in operation by the user.

The controller 180 of the first TV may transmit the contents identifier to the server 4 in order to search for the bookmarked contents. The controller 180 may also transmit the reproduction point state variable to the server 4 in order to play the searched contents.

The server 4 may transmit the searched contents to the first TV 17 linked to the server based on the reproduction point state variable. Accordingly, the user can enjoy the bookmarked contents seamlessly without performing an additional authentication procedure.

The controller 180 of the first TV 17 may output the bookmarked contents through the output unit 150 based on bookmark (c) illustrated in FIG. 11. It is assumed that the contents are stored in an electronic device other than the first TV 17, such as the first computer 13, according to the time shift function illustrated in FIG. 9 in the following description.

The controller 180 of the first TV 17 may determine that the contents are stored in the first computer 13 according to the time shift function based on the contents storage position. The controller 180 may transmit the contents identifier to the first computer 13 in order to search for the contents stored by the time shift function.

The first computer 13 may search for the contents based on the contents identifier received from the first TV 17 and transmit the searched contents to the first TV. The first TV 17 may output the contents received from the first computer 13 through the output unit 150 based on the rendering state variable.

The controller 180 of the first TV 17 may output the bookmarked contents through the output unit 150 based on bookmark (d) illustrated in FIG. 11. The controller 180 may output the contents stored according to the time shift function illustrated in FIG. 9 through the output unit 150 based on the rendering state variable.

Playing the contents when the generated bookmark is stored in an electronic device other than the electronic device outputting the contents will now be explained. As previously explained, when the generated bookmark is stored in an electronic device other than the first TV 17 that generated the bookmark, the first TV may store the bookmark identifier in the memory 160 of the first TV. Furthermore, the first TV 17 may store information on the bookmark storage position information in the memory 160.

When use of the bookmark is selected, the first TV 17 may detect the electronic device in which the bookmark is stored based on the bookmark storage position. The first TV 17 may then transmit the bookmark identifier to the detected electronic device.

The electronic device that receives the bookmark identifier from the first TV 17 may search for the bookmark based on the bookmark identifier and transmit the contents identifier included in the searched bookmark to the first TV based on the reproduction point state variable. Furthermore, the electronic device receiving the bookmark identifier from the first TV 17 may transmit the searched contents based on the reproduction point state variable to the electronic device corresponding to the identifier of the electronic device that will output the bookmarked contents that is included in the bookmark.

Referring again to FIG. 4, the controller 180 of the first TV 17 may automatically delete the bookmark when either the contents have been played based on the bookmark or the “refusal” icon is selected via the user interface 155 illustrated in FIG. 12 (S580).

The controller 180 of the first TV 17 can automatically delete the bookmark (S580) to increase storage space. Furthermore, when the “refusal” icon is selected, the controller 180 may inquire of the user whether to delete the bookmark.

When the bookmark is deleted (S580), the controller 180 of the first TV 17 may also automatically delete the contents stored according to the time shift function. If the contents are stored in an electronic device other than the first TV 17 according to the time shift function, the controller 180 may request that electronic device to delete the stored contents.

Whether the bookmark is automatically deleted may be determined by the user. The controller 180 may not automatically delete the bookmark such that the user can use the bookmark later. Furthermore, the controller 180 may provide a user interface through the output unit 150 for inquiring about whether to delete the bookmark in order to provide the user a choice.

The method illustrated in FIG. 4 has been explained on the assumption that the first TV 17 currently outputting the contents determines whether the bookmark generation standard is satisfied. However, the electronic device generating the event may determine whether the bookmark generation standard is satisfied such that the electronic device generating the event may transmit a control signal for generating a bookmark to an electronic device that satisfies the bookmark generation standard.

For example, the electronic device generating the event can transmit the control signal to the first TV 17 currently outputting the contents. When the first TV 17 receives the control signal, the first TV can generate the bookmark for the currently output contents according to the method illustrated in FIG. 4.

The method illustrated in FIG. 4 has been explained on the assumption that an electronic device generating the event transmits the event related information to the electronic device that belongs to the same network and is currently outputting contents. However, the method illustrated in FIG. 4 is also applicable when the electronic device generating the event transmits the event related information to an electronic device that belongs to the same network but does not output contents.

It is assumed that the electronic device that belongs to the network to which the electronic device generating the event belongs but does not output contents is the first computer 13. The first computer 13 may be an electronic device that provides contents to the first TV 17 or manages the network 1, for example.

As illustrated in FIG. 4, the first TV 17 outputs contents (S510). The first computer 13 detects an event generated in the network 1 (S520) and may receive information related to the event from an electronic device that is designated to the user of the first computer or that belongs to the network to which the first computer belongs.

Upon the generation of the event, the first computer 13 may detect the electronic device currently playing contents in the network 1. For example, the first computer 13 can detect the electronic device currently outputting contents by inquiring of the electronic devices in the network 1 about whether the electronic devices are currently outputting contents.

The first computer 13 may determine whether to generate a bookmark for the currently output contents based on the bookmark generation standard. Specifically the first computer 13 can determine whether to generate the bookmark for the contents currently output from the first TV 17 according to at least whether the first TV and the electronic device generating the event belong to the same local network, whether the first TV and the electronic device generating the event belong to the same user, or whether the priority of the event is higher than a priority of contents playback.

The first computer 13 may transmit the control signal for generating a bookmark to the electronic device currently outputting the contents, such as the first TV 17, when the bookmark generation standard is satisfied. The electronic device currently outputting the contents may generate the bookmark for the currently output contents when receiving the control signal (S540).

Providing a user interface (S550), playing the contents (S570) and deleting the bookmark (S580) have been previously described. Therefore, no further description is necessary.

The first computer 13 may generate the bookmark according to the control signal. For example, the first computer 13 may obtain information required to generate the bookmark from the electronic device currently outputting the contents.

The first computer 13 may store the generated bookmark itself or in the electronic device currently outputting the contents. If the first computer 13 stores the bookmark in the electronic device currently outputting the contents, the first computer may transmit information related to the bookmark to the first TV 17. If the first computer 13 stores the bookmark itself, the bookmark may further include the identifier of an electronic device that will output the bookmarked contents.

The identifier of an electronic device that will output the bookmarked contents may indicate the first TV 17. As previously described, when the identifier of an electronic device that will output the bookmarked contents is used, the bookmarked contents can be automatically transmitted to the electronic device corresponding to the identifier when using the generated bookmark. When the event is generated, the first computer 13 generates the bookmark for the contents currently output from the first TV 17 and, when the contents are played according to the bookmark, provides the bookmarked contents to the first TV designated by the identifier as the electronic device that will output the bookmarked contents.

When the generated bookmark is stored in the first computer 13, the first computer may transmit minimum information required to identify the bookmark to the first TV 17 to inform the first TV that the bookmark for the contents has been generated. The minimum information required to identify the bookmark may include at least the bookmark identifier or the bookmark storage position.

Furthermore, the first computer 13 may transmit other information related to the generated bookmark to the first TV 17. The other information related to the generated bookmark may include at least a reproduction point state variable, a rendering state variable, the bookmark title, or the contents title.

When the electronic device currently outputting the contents is requested to use the bookmark, the electronic device may request that the first computer 13 provide the bookmarked contents based on the bookmark identifier and the bookmark storage position. The first computer 13 may search for the bookmarked contents based on the bookmark identifier and transmit the searched contents based on the reproduction point state variable. Furthermore, the first computer 13 may transmit the searched contents to the electronic device designated by the identifier as the electronic device that will output the bookmarked contents, such as the first TV 17.

When the contents currently output from the first TV 17 are stored in the second computer 15, the first computer 13 may determine that the bookmarked contents are stored in the second computer based on the contents storage position. The first computer 13 may then transmit the contents identifier, which is the identifier of an electronic device that will output the bookmarked contents, and the reproduction point state variable. The second computer 15 may search for the bookmarked contents based on the contents identifier and transmit the searched contents to the first TV 17 designated by the identifier based on the reproduction point state variable.

According to this method, an electronic device can automatically generate a bookmark when an event is generated in another electronic device while the electronic device is playing contents. Accordingly, the user can continuously watch the contents, which cannot be watched for a time due to the event, by using the bookmark and can enjoy the contents seamlessly.

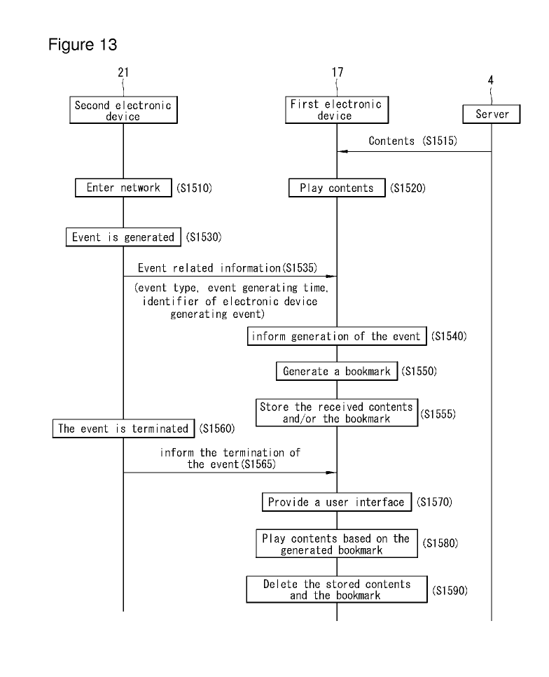

FIG. 13 is a flowchart illustrating a method of generating a bookmark and using the generated bookmark according to an embodiment of the present invention. The first electronic device illustrated in FIG. 13 may receive contents from a server and output the received contents. It is assumed that the first electronic device is the first TV 17, the server is a broadcasting server 4, and the second electronic device is the first cellular phone 21.

The first cellular phone 21 enters from outside the network 1 (S1510). As described with reference to FIG. 5, the first cellular phone 21 can recognize the first TV 17 and the first TV can recognize the first cellular phone 21.

The first TV 17 receives contents, such as a broadcasting signal, from the broadcasting server (S1515). For example, the first TV 17 can receive a broadcasting signal from a broadcasting station. The first TV 17 plays the contents by outputting the received broadcasting signal via the output unit 150 (S1520).

An event is generated in the first cellular phone 21 (S1530). It is assumed that the event corresponds to receiving a call signal. When the call signal receiving event is generated, the first cellular phone 21 transmits information related to the event (S1535). The event related information may include at least generation of a call signal as the event type, a call signal receiving time as the event generation time, or the device identifier of the first cellular phone 21 as the identifier of the electronic device generating the event.

The first cellular phone 21 may transmit the event related information to the first TV 17 designated to the user of the first cellular phone 21 and included in the local network 1 to which the first cellular phone 21 belongs. When the first TV 17 receives the event related information, the first TV informs the user that the event is generated via the output unit 150 (S1540). The first TV 17 generates a bookmark for the currently output contents when the event related information is received (S1550).

For example, the first TV 17 can determine whether a priority of the event generated in the first cellular phone 21 is higher than the priority of contents playback based on the received event related information. When the first TV 17 determines that the priority of the event generated in the first cellular phone 21 is higher than the priority of contents playback, the first TV generates the bookmark for the currently output contents (S1550). For example, the first TV 17 can generate bookmark (c) or (d) illustrated in FIG. 11.

It is assumed that the first TV 17 generates bookmark (c). The generated bookmark may include at least the bookmark identifier, the contents identifier, the bookmark storage position, or the contents storage position.

The bookmark identifier may be a bookmark serial number, such as 100. The bookmark serial number may be a value for identifying the bookmark in the network 1. The contents identifier may be “2010.08.07(bookmark generating date)//200,155,235 bytes(file size of contents stored according to the time shift function)//19(serial number).”

The bookmark storage position may correspond to the first TV 17. The contents storage position may be “First TV//contents\” stored by time shift when the contents are stored in the first TV 17 according to the time shift function.

The controller 180 of the first TV 17 may store a broadcasting signal received after the bookmark is generated by using the time shift function (S1555). When the call is terminated (S1560), the first cellular phone 21 may transmit a message informing the first TV 17 that the call is terminated (S1565). When the first TV 17 receives the call termination message from the first cellular phone 21, the controller 180 of the first TV may provide a user interface 155 illustrated in FIG. 12 via the output unit 150 for inquiring about whether to use the generated bookmark (S1570).

When the user selects to use of the bookmark via the user interface 155, the controller 180 of the first TV 17 plays the contents based on the generated bookmark (S1580). The controller 180 of the first TV 17 may find a folder of the contents stored by the time shift function based on the contents storage position, search for the contents stored by the time shift function based on the contents identifier and output the searched contents through the output unit 150 of the first TV 17. The controller 180 of the first TV 17 may delete the bookmark and the stored contents after outputting the contents based on the bookmark (S1590).

Accordingly, the user can watch the contents from the point at which the user stopped watching the contents due to the generation of the call. Although the cellular phone has been described as an electronic device in the current embodiment of the present invention, the present invention is not limited to a cellular phone and any mobile terminal can be used as an electronic device.

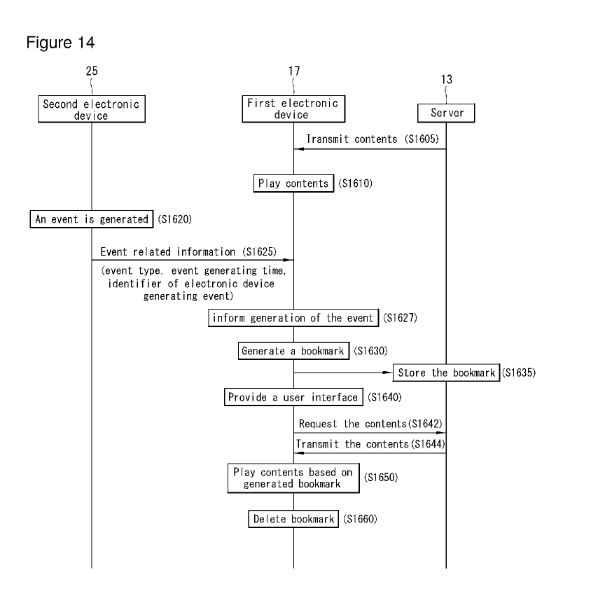

FIG. 14 is a flowchart illustrating a method of generating a bookmark and using the generated bookmark according to another embodiment of the present invention. The first electronic device shown in FIG. 14 receives contents from a server and outputs the received contents. It is assumed that the first electronic device is the first TV 17, the server is the first computer 13, and the second electronic device is a home appliance 25, such as a doorbell.

The first TV 17 receives the contents from the first computer 13 (S1605) and outputs the received contents via the output unit 150 (S1610). It is assumed that the title of the contents is “superman.”

An event is generated in the doorbell 25 (S1620). It is assumed that the event corresponds to generation of a ring signal.

When the event corresponding to the generation of the ring signal is generated, the doorbell 25 may transmit information related to the event to the first TV 17 (S1625). The event related information may include at least ringing the doorbell as the event type, event generating time, the doorbell identifier as the identifier of the electronic device generating the event, or the priority of the ringing doorbell. The first TV 17 informs the user via the output unit 150 that the event is generated (S1627).

The controller 180 of the first TV 17 may determine whether to generate a bookmark based on at least whether the doorbell is included in the network 1 to which the first TV 17 belongs, whether the doorbell is designated to the user of the first TV 17, or whether a priority of the ringing doorbell is higher than a priority of contents playback.

The controller 180 outputs a control signal for generating a bookmark for the currently output contents when the controller determines that the doorbell is included in the network 1 to which the first TV 17 belongs, the doorbell is designated to the user of the first TV or the priority of the ringing doorbell is higher than the priority of contents playback (S1630).

The generated bookmark may have the structure of bookmark (a) or (b) illustrated in FIG. 11. It is assumed that the generated bookmark has the structure of bookmark (a). The bookmark may include at least the bookmark identifier, the contents identifier, the bookmark storage position, the contents storage position, the reproduction point state variable, or the identifier of an electronic device that will output the bookmarked contents.

The bookmark identifier may be “superman(contents title)//700, 265,584(contents file size)//2010.08.07(contents creating date)//2010.08.10(bookmark generating date)//15(serial number).” The contents identifier may be “superman(contents title)//700,265,582(contents file size)//2010.08.07(contents creating date).”

The bookmark storage position may correspond to “First computer(identifier of the electronic device storing the bookmark)//bookmark\(folder storing the generated bookmark)” when the bookmark is stored in the first computer 13. The contents storage position may be “First computer(identifier of the electronic device storing the contents)//contents\superman.avi(contents folder).”

The reproduction point state variable may be 0 hour 29 minutes 38 seconds, which represents that the bookmark is generated 29 minutes 38 seconds after “superman” is started. The identifier of an electronic device that will output the bookmarked contents may be the first TV 17 currently playing the contents.

When the first TV 17 receives the event related information, the first TV may transmit a control signal for generating a bookmark to other electronic devices that are outputting contents in order to generate bookmarks for the contents currently output from the other electronic devices. The first TV 17 may transmit the generated bookmark to the first computer 13 to store the bookmark in the first computer (S1635). The first TV 17 can also store the bookmark identifier and the bookmark storage position corresponding to the bookmark in the memory 160.

The controller 180 of the first TV 17 may provide a user interface 155 as illustrated in FIG. 12 for inquiring about whether to use the generated bookmark (S1640). The controller 180 may provide the user interface 155 a predetermined amount of time after the event is generated. The controller 180 may determine whether the predetermined amount of time has elapsed based on the event generating time included in the event related information. The user may select the use of the bookmark through the user interface 155.

The first TV 17 may request the first computer 13 to provide the contents based on the information included in the bookmark (S1642). For example, the first TV 17 may determine that the bookmark is stored in the first computer 13 based on the bookmark storage position and transmit the bookmark identifier to the first computer.

The first computer 13 may search for the bookmark based on the bookmark identifier received from the first TV 17 and search for the bookmarked contents “superman” based on the contents identifier included in the searched bookmark. The first computer 13 may also transmit “superman” starting from a point corresponding to 29 minutes 38 seconds, which is designated by the reproduction point state variable, to the electronic device that will output the bookmarked contents, such as the first TV (S1644).

The first TV 17 plays “superman” starting from the point corresponding to 29 minutes 38 seconds (S1650). The first TV 17 may automatically delete the bookmark after playing the contents (S1660) by requesting the first computer 13 to delete the stored bookmark.

According to the present invention, an electronic device can automatically generate a bookmark for contents currently output from the electronic device when an event is generated in another electronic device while the electronic device is outputting the contents. This provides an environment in which the user can enjoy the contents seamlessly.

Depending on implementation, it is possible that the present invention can take the form of an entirely hardware embodiment, an entirely software embodiment or an embodiment containing both hardware and software elements. A software embodiment may include, but not be limited to, to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer readable recording medium includes all types of recording devices storing data readable by computer systems. Examples of the computer readable recording medium include ROM, RAM, CD-ROM, DVD±ROM, DVD-RAM, magnetic tapes, floppy disks, hard disks, and optical data storage devices. The computer readable recording medium can also be distributed over network coupled computer systems so that the computer readable code is stored and executed in a distributed fashion.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Other components may be coupled to the system. Input/output or I/O devices (including but not limited to keyboards, displays, and pointing devices) can be coupled to the system either directly or through intervening I/O controllers. Network adapters (e.g., modem, cable modem, Ethernet cards) may also be coupled to the system to enable the data processing system to be coupled to other data processing systems or remote printers or storage devices via intermediate private or public networks.

It should be understood that the logic code, programs, modules, processes, methods, and the order in which the respective elements of each method are performed are purely exemplary. Depending on the implementation, the elements may be performed in any order or in parallel, unless indicated otherwise in the present disclosure. Further, the logic code is not related, or limited, to any particular programming language, and may be comprise one or more modules that execute on one or more processors in a distributed, non-distributed, or multiprocessing environment.

The methods as described herein may be used in the fabrication of integrated circuit chips. The resulting integrated circuit chips can be distributed by the fabricator in raw wafer form such as a single wafer that has multiple unpackaged chips, as a bare die, or in a packaged form. In the latter case, the chip is mounted in a single chip package (such as a plastic carrier with leads that are affixed to a motherboard or other higher level carrier) or in a multi-chip package (such as a ceramic carrier that has either or both surface interconnections of buried interconnections).

The chip is then integrated with other chips, discrete circuit elements, and/or other signal processing devices as part of either an intermediate product, such as a motherboard, or an end product. The end product can be any product that includes integrated circuit chips, ranging from toys and other low-end applications to advanced computer products having a display, a keyboard or other input device, and a central processor.

Therefore, it should be understood that the invention can be practiced with modification and alteration within the spirit and scope of the appended claims. The description is not intended to be exhaustive or to limit the invention to the precise form disclosed. These and various other adaptations and combinations of the embodiments disclosed are within the scope of the invention and are further defined by the claims and their full scope of equivalents.

As the present invention may be embodied in several forms without departing from the spirit or essential characteristics thereof. It should also be understood that the above-described embodiments are not limited by any of the details of the foregoing description, unless otherwise specified, but rather should be construed broadly within its spirit and scope as defined in the appended claims. Therefore, all changes and modifications that fall within the metes and bounds of the claims, or equivalence of such metes and bounds, are intended to be embraced by the appended claims.

The foregoing embodiments and advantages are merely exemplary and are not to be construed as limiting the present invention. The present teaching can be readily applied to other types of apparatuses.

The description of the present invention is intended to be illustrative, and not to limit the scope of the claims. Many alternatives, modifications, and variations will be apparent to those skilled in the art. In the claims, means-plus-function clauses are intended to cover the disclosed structure as performing the recited functions and not only structural equivalents, but also equivalent structures.

What is claimed is:

1. A method for generating a bookmark related to contents output by an electronic device, the method comprising:
outputting the contents from the electronic device;
receiving information in the electronic device, the information related to an event generated in a different electronic device while the contents are output from the electronic device;
generating the bookmark in the electronic device that is related to the contents; and
outputting information related to the generated bookmark from the electronic device.

2. The method of claim 1, further comprising no longer outputting the contents from the electronic device upon generating the bookmark.

3. The method of claim 2, further comprising resuming output of the contents from the electronic device based on the generated bookmark upon receiving information related to termination of the event.

4. The method of claim 3, further comprising storing at least the contents or the information related to the generated bookmark while no longer outputting the contents, wherein resuming output of the contents comprises obtaining at least the stored contents or the stored information related to the generated bookmark.

5. The method of claim 4, wherein at least the contents or the information related to the generated bookmark is stored in the electronic device.

6. The method of claim 4, wherein at least the contents or the information related to the generated bookmark is stored in a server.

7. The method of claim 4, further comprising:
determining if time information related to the contents is available;
storing the contents if the time information is not available; and
not storing the contents if the time information is available.

8. The method of claim 7, wherein determining if time information related to the contents is available comprises determining if a reproduction state variable is received.

9. The method of claim 3, wherein resuming output of the contents comprises:
providing a user interface upon receiving the information related to termination of the event; and
resuming output of the contents according to user input received via the user interface.

10. The method of claim 3, further comprising deleting the generated bookmark upon completion of the output of the contents based on the generated bookmark.

11. The method of claim 1, wherein generating the bookmark comprises:
determining a priority of the generated event based on the received information related to the event; and
comparing the determined priority of the generated event to a priority of the contents being output.

12. The method of claim 1, wherein generating the bookmark comprises determining whether the generated event is related to the electronic device, the determination based on the received information related to the event.

13. The method of claim 1, wherein the electronic device and the different electronic device each are a computer, a television, a cellular phone, a home appliance, a digital broadcasting terminal, a personal digital assistant (PDA), a portable multimedia player (PMP), a navigation system or a mobile Internet device.

14. The method of claim 1, wherein the electronic device and the different electronic device use different protocols and receiving the information in the electronic device comprises protocol conversion.

15. An electronic device for generating a bookmark related to contents that are output by the electronic device, the electronic device comprising:
an output unit configured to output the contents from the electronic device;
a receiving unit configured to receive information related to an event generated in a different electronic device while the contents are output by the output unit; and
a controller configured to generate the bookmark that is related to the contents and control the output unit to output information related to the generated bookmark.

16. The electronic device of claim 15, wherein the controller is further configured to control the output unit to no longer output the contents upon generating the bookmark.

17. The electronic device of claim 15, wherein the controller is further configured to control the output unit to resume output of the contents based on the generated bookmark upon receiving information related to termination of the event.

18. The electronic device of claim 17, wherein the controller is further configured to:
store at least the contents or the information related to the generated bookmark while controlling the output unit to no longer output the contents; and
obtain at least the stored contents or the stored information related to the generated bookmark when controlling the output unit to resume output of the contents.

19. The electronic device of claim 18, further comprising a storage unit configured to store information, wherein the controller is further configured to control the storage unit to store at least the contents or the information related to the generated bookmark while controlling the output unit to no longer output the contents.

20. The electronic device of claim 18, wherein the controller is further configured to transfer the contents to a server for storage while controlling the output unit to no longer output the contents.

21. The electronic device of claim 18, wherein the controller is further configured to:
determine if time information related to the contents is available;
store the contents if the time information is not available; and
not store the contents if the time information is available.

22. The electronic device of claim 21, wherein determining if time information related to the contents is available comprises determining if a reproduction state variable is received.

23. The electronic device of claim 17, further comprising a display unit configured to at least display information and wherein the controller is further configured to:
control the display unit to provide a user interface upon receiving the information related to termination of the event; and
control the output unit to resume output of the contents according to user input received via the user interface.

24. The electronic device of claim 17, wherein the controller is further configured to delete the generated bookmark upon completion of the output of the contents based on the generated bookmark.

25. The electronic device of claim 15, wherein the controller is further configured to generate the bookmark by:
determining a priority of the generated event based on the received information related to the event; and
comparing the determined priority of the generated event to a priority of the contents being output.

26. The electronic device of claim 15, wherein the controller is further configured to generate the bookmark by determining whether the generated event is related to the electronic device, the determination based on the received information related to the event.

27. The electronic device of claim 15, wherein the electronic device and the different electronic device each are a computer, a television, a cellular phone, a home appliance, a digital broadcasting terminal, a personal digital assistant (PDA), a portable multimedia player (PMP), a navigation system or a mobile Internet device.

28. The electronic device of claim 15, wherein the electronic device and the different electronic device use different protocols and receiving the information in the electronic device comprises protocol conversion.
